(19) United States
(12) Patent Application Publication
(10) Pub. No.: US 2026/0109369 A1
(43) Pub. Date: Apr. 23, 2026

(54) MOTOR VEHICLE, METHOD FOR OPERATING A MOTOR VEHICLE

(71) Applicant: Robert Bosch GmbH, Stuttgart (DE)

(72) Inventors: Philipp Seibold, Fellbach (DE); Carsten Bodmann, Ludwigsburg (DE); Jens Kolarsky, Bietigheim/Bissingen (DE)

(21) Appl. No.: 19/352,054

(22) Filed: Oct. 7, 2025

(30) Foreign Application Priority Data
Oct. 18, 2024 (DE) 10 2024 210 087.0

(51) Int. Cl. B60W 50/10; B60K 26/02; B60T 7/02; B60W 10/04; B60W 10/18; B60W 10/20; B62D 1/02

(52) U.S. Cl. CPC B60W 50/10; B60K 26/02; B60T 7/02; B62D 1/02; B60W 10/04; B60W 10/18; B60W 10/20

(57) ABSTRACT

A motor vehicle. The motor vehicle includes: at least two sensor arrangements for detecting an actuation of an actuation device; at least one actuator controllable to fulfill a driver request, which actuator is selected from a group of braking, driving and steering actuators; a central control unit configured to ascertain the driver request on the basis of sensor signals from at least one of the sensor arrangements; and a control unit configured to control the actuator based on the ascertained driver request the central control unit being communicatively connected to the control unit. One of the sensor arrangements is communicatively connected exclusively to the central control unit and another of the sensor arrangements is communicatively connected exclusively to the control unit, and the control unit is configured to ascertain the driver request based on sensor signals from the sensor arrangement connected to the control unit.

### FIELD

The present invention relates to a motor vehicle, comprising at least one actuation device, in particular a pedal or handle, for specifying at least one driver request selected from a group of braking, acceleration and steering requests; at least two sensor arrangements for detecting an actuation of the actuation device, comprising at least one actuator controllable to fulfill the driver request, which actuator is selected from a group of braking, driving and steering actuators; at least one central control unit configured to ascertain the driver request on the basis of sensor signals from at least one of the sensor arrangements; and at least one control unit configured to control the actuator on the basis of the ascertained driver request, the central control unit being communicatively connected to the control unit.

Moreover, the present invention relates to a method for operating such a motor vehicle.

### BACKGROUND INFORMATION

Motor vehicles of the aforementioned type are described in the related art. For example, Germany Patent Application No. DE 10 2021 215 007 A1 describes a generic vehicle having a braking system, comprising a primary brake actuator having a first control device and a secondary brake actuator having a second control device, a central control device that is connected to the first and the second control device via communication means, wherein a braking command is receivable by means of the central control device from a first control unit of a brake actuation unit or from a further control device, and, based on the braking command, the primary and/or secondary brake actuator is controllable by the central control device. The first control unit transmits, via communication means, for example two independent signal lines, two braking commands to the central control unit, each based on different sensors. The braking commands are not transmitted directly to the brake actuators.

Germany Patent Application No. DE 10 2021 110 472 A1 describes a braking system for a vehicle having at least four brakeable wheels, comprising at least four brake actuator units, each of which is assignable to one of the wheels of the vehicle, a first and a second electronic control device, wherein each brake actuator unit is connected, for signaling purposes, to the first and the second control device, so that each of the brake actuator units is actuatable both by means of the first control device and by means of the second control device. A brake actuation unit is provided that is coupled, for signaling purposes, to both the first and the second control device, wherein the brake actuation unit comprises in particular a brake pedal. In addition, pedal travel sensors and pedal force sensors are provided within the brake actuation unit. A signal generated by the brake actuation unit, which in particular represents a driver request, may be taken into account in both the first and the second control device.

### SUMMARY

According to an example embodiment of the present invention, a motor vehicle according to present invention includes: at least one actuation device, in particular a pedal or handle, for specifying at least one driver request selected from a group of braking, acceleration and steering requests; at least two sensor arrangements for detecting an actuation of the actuation device; at least one actuator controllable to fulfill the driver request, which actuator is selected from a group of braking, driving and steering actuators; at least one central control unit configured to ascertain the driver request on the basis of sensor signals from at least one of the sensor arrangements, and at least one control unit configured to control the actuator on the basis of the ascertained driver request, the central control unit being communicatively connected to the control unit. One of the sensor arrangements is communicatively connected, in particular exclusively, to the central control unit and another of the sensor arrangements is communicatively connected, in particular exclusively, to the control unit, and in that the control unit is configured to ascertain the driver request on the basis of sensor signals of the sensor arrangement connected to the control unit. In the motor vehicle according to the present invention, the actuator may be controlled either directly by the control unit or indirectly by the central control unit. At the central control unit, further data of the motor vehicle, preferably sensor data, are consolidated, such that the central control unit is configured to ascertain the driver request not only on the basis of sensor signals of the corresponding sensor arrangement, but also on the basis of further sensor signals and/or vehicle information relating to the motor vehicle, in particular a current regenerative braking potential, and/or environmental information. The driver request is thus modifiable depending on the situation; in particular, the control unit receives a driver request ascertained by linking or merging a plurality of data, in particular sensor signals. However, if the central control unit, the sensor arrangement connected thereto, or a communication connection between the sensor arrangement, the central control unit and/or the control unit fails, or if implementation of the driver request with minimal delay, for example in an emergency situation, is required, the additional direct connection according to the present invention of the control unit to one of the sensor arrangements advantageously ensures that the driver request can be implemented reliably, and that both fail-safety is advantageously further increased and response time is further improved when required. The detour via the central control unit is advantageously avoided, particularly to avoid latency, by the control unit directly controlling the actuator on the basis of the sensor signals. The system described remains safely operational. This differs from the related art mentioned at the outset, which does indeed disclose braking systems having increased fail-safety, but either explicitly provides no direct connection between the sensor arrangement and the control unit that is subordinate to the central control unit under normal operation, or provides no such dependency at all, and instead only two redundant control units, whereas the present invention does not require these. The core of the present invention lies in a novel interconnection of the components, specifically the additional communication connection between the control unit and at least one of the sensor arrangements, and in their configuration to directly control the actuator on the basis of the sensor signals, bypassing the central control unit as needed in the event of a fault or in time-critical situations. In particular, the motor vehicle has a plurality of central control units and/or control units.

According to a preferred development of the present invention, the central control unit is configured to transmit the ascertained driver request to the control unit via the communication connection, and the control unit is configured to receive the transmitted driver request. Such a configuration of the central control unit and the control unit advantageously ensures that the driver request is implemented jointly by the central control unit and the control unit. As described above, the central control unit is configured in particular to evaluate the sensor signals, preferably to merge them with further sensor signals and/or vehicle/environmental information, and/or to modify the driver request accordingly before it is transmitted to the control unit.

Particularly preferably, the central control unit is redundantly connected to the control unit by means of at least two communication connections. Such a redundant connection has the advantage of further improving overall fail-safety. For example, two independent connections, in particular separate data lines, are used.

According to a preferred development of the present invention, at least one of the sensor arrangements has at least one first and one second sensor element for redundantly detecting the actuation, wherein the sensor elements in particular have different measuring principles. The use of a plurality of sensor elements advantageously ensures that the actuation continues to be reliably detected even if one of the sensor elements fails. This also further improves overall reliability. If different measuring principles are used, an advantageous heterogeneous redundancy is created, for example by a force sensor and a displacement sensor.

Particularly preferably, the first sensor element and the second sensor element are each communicatively connected, in particular separately, to the control unit or to the central control unit. Such a connection of the sensor elements results in the advantage that the actuation is reliably detected by the control unit and the central control unit by means of the corresponding sensor arrangement. Preferably, both sensor arrangements each have at least two sensor elements, wherein the first sensor arrangement having both sensor elements is connected to the control unit and the second sensor arrangement having both sensor elements is connected to the central control unit. For example, each of the sensor elements is connected via a separate connection in order to advantageously further increase fail-safety.

According to a preferred development of the present invention, the motor vehicle has, in addition to the control unit, at least one further control unit assigned to the actuator or to a further actuator, and the first sensor element is communicatively connected, in particular separately, to the control unit, and the second sensor element is communicatively connected, in particular separately, to the further control unit. By distributing the sensor elements among the control units in this way, it is advantageously ensured that, with only one sensor arrangement, both control units are each supplied directly with sensor signals.

Particularly preferably, according to an example embodiment of the present invention, the motor vehicle has a braking system, in particular according to the brake-by-wire principle, and the actuator is configured as a brake actuator of the braking system, and the control unit is configured as a brake control unit of the braking system assigned, in particular exclusively, to the actuator. In such a configuration of the actuator and control unit, the advantages of the motor vehicle according to the present invention are particularly pronounced. In this respect, it corresponds to the related art mentioned at the outset. Alternatively or additionally, the motor vehicle has a drive system, wherein the actuator is configured as a drive actuator of the drive system, and the control unit is configured as a drive control unit of the drive system assigned, in particular exclusively, to the actuator. Alternatively or additionally, the motor vehicle has a steering system, wherein the actuator is configured as a steering actuator of the steering system, and the control unit is configured as a steering control unit of the steering system assigned, in particular exclusively, to the actuator. The particular system is configured in particular according to the by-wire principle (brake-by-wire, steer-by-wire, drive-by-wire) without a mechanical fallback level or mechanical coupling between the actuator and the actuation device. Any desired combinations are also possible in which in particular the central control unit is in each case connected to a corresponding brake control unit, drive control unit and/or steering control unit. In particular, the motor vehicle has at least one actuator of each type (braking, driving, steering) with at least one control unit of each type.

According to an example embodiment of the present invention, the method for operating the motor vehicle according to the present invention includes that the driver request is ascertained during normal operation of the motor vehicle by means of the central control unit, transmitted to the control unit via the communication connection, and received by the control unit, and in that the actuator is controlled by means of the control unit on the basis of the ascertained driver request. Such a procedure advantageously ensures that the driver request is implemented jointly by the central control unit and the control unit.

Particularly preferably, the sensor signals of the corresponding sensor arrangement are evaluated by the central control unit, merged with further sensor signals and/or vehicle/environmental information, and/or the driver request is modified accordingly before it is transmitted to the control unit.

According to a preferred development of the present invention, the motor vehicle is monitored for a malfunction and/or an emergency situation, and, if a malfunction and/or emergency situation is detected, the driver request is ascertained instead by means of the control unit, and the actuator is directly controlled by means of the control unit on the basis of the ascertained driver request. By appropriately taking into account malfunctions and/or emergency situations, it is advantageously ensured that the driver request is always implemented reliably, and that both fail-safety in the event of a malfunction is advantageously further increased and response time in an emergency situation is further improved. An emergency situation exists, for example, when full braking and/or an evasive maneuver is requested in order to avoid an accident or at least to mitigate the consequences of an accident. The emergency situation is detected in particular by a gradient analysis of an actuation of the actuation device, for example when a change in the actuation at least reaches a predetermined threshold value, i.e., the actuation device is actuated particularly quickly or strongly. Detection of an emergency situation is reported in particular to at least one further control unit, wherein preconditioning of components of the motor vehicle preferably takes place, for example if an accident can no longer be avoided, such as activation of belt tensioners or execution of a predetermined pre-crash scenario. Usually, the driver request is, during normal operation, for example during comfort braking, ascertained by the central control unit and transmitted to the control unit. The central control unit is bypassed in an emergency situation in order to reduce the response time and thus, for example, the braking distance during an emergency braking procedure.

Particularly preferably, according to an example embodiment of the present invention, the central control unit, the sensor arrangement connected to the central control unit, the communication connection between the central control unit and the sensor arrangement and/or the communication connection between the central control unit and the control unit is monitored for a malfunction. Comprehensive monitoring of malfunctions that can be controlled by the motor vehicle according to the present invention and the described communication interconnection of the components is thereby provided. Even if all of the aforementioned components and connections malfunction, the driver request will still be implemented reliably.

Further preferred features and combinations of features result from what was described above and from the rest of the disclosure herein. The present invention is explained in more detail below with reference to the figures.

### BRIEF DESCRIPTION OF THE DRAWINGS

FIG. 1 shows components of an advantageous motor vehicle according to an example embodiment of the present invention.

FIG. 2 shows a method for operating the motor vehicle, according to an example embodiment of the present invention.

### DETAILED DESCRIPTION OF EXAMPLE EMBODIMENTS

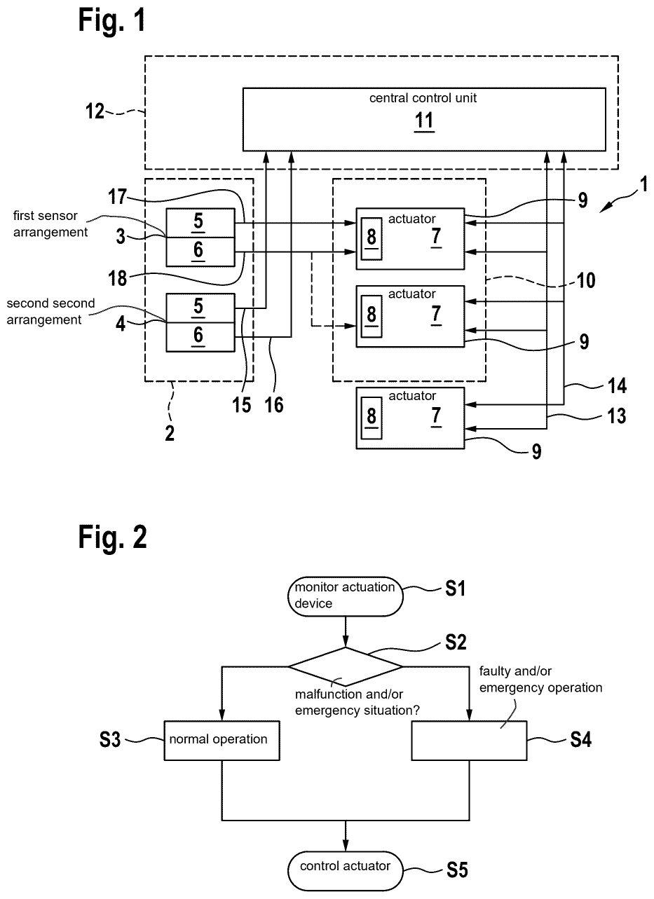

FIG. 1 shows, merely schematically, an exemplary embodiment of components of an advantageous motor vehicle 1. The motor vehicle 1 has at least one actuation device 2 that is actuatable by a driver of the motor vehicle to specify at least one driver request. The driver request is selected from a group of braking, acceleration and steering requests. The actuation device 2 is configured in particular as a pedal, for example an accelerator pedal, gas pedal and/or brake pedal, or as a handle, for example a steering wheel or joystick.

The motor vehicle 1 further comprises at least two sensor arrangements 3, 4 assigned to the actuation device 2, in the present case a first sensor arrangement 3 and a second sensor arrangement 4. The sensor arrangements 3, 4 are each configured to detect an actuation of the actuation device 2, for example an actuating force exerted on the actuation device 2, a displacement path of the actuation device 2, and/or a rotational position of the actuation device 2.

Each of the sensor arrangements 3, 4 has at least one sensor element 5, 6, for example a force sensor, a displacement sensor and/or a rotary angle sensor. In the present case, each of the sensor arrangements 3, 4 has a first sensor element 5 and a second sensor element 6 for redundantly detecting the actuation. In particular, the sensor elements 5, 6 have different measuring principles. For example, the first sensor element 5 is designed as a force sensor and the second sensor element 6 as a displacement sensor.

The motor vehicle 1 further comprises at least one actuator 7 controllable to fulfill the driver request, in the present case a plurality of actuators 7. The particular actuator 7 is selected from a group of braking, driving and steering actuators. In addition, the motor vehicle has at least one control unit 8, in the present case a plurality of control units 8.

In the present case, each of the actuators is exclusively assigned exactly one of the control units 8, in particular being formed together therewith as a common assembly. Each one of the actuators 7, together with the control unit 8 assigned thereto, forms part of a device 9 that is actuatable by that actuator. The particular device 9 is selected from a group of braking, driving, and steering devices.

A plurality of the devices form, in particular, part of a common system 10, in particular according to the by-wire principle. The particular system 10 is selected from a group of braking, driving and steering systems. Merely by way of example, in the present case two of the devices 9 form part of a common system 10, and a further of the devices 9 is configured or arranged separately therefrom.

For example, in the present case the system 10 is a braking system, so that the devices 9 are correspondingly braking devices, the actuators 7 are brake actuators, and the control units 8 are braking control units. The further device 9 is then, for example, a drive device, having the corresponding actuator 7 as the drive device, and the corresponding control unit 8 as the drive control unit.

Finally, the motor vehicle 1 also has at least one central control unit 11, which in the present case forms part of a central control system 12, which preferably has further central control units 11 (not shown). The central control unit 11 is communicatively connected to each of the control units 8; in particular it is configured as a cross-domain control unit in order to communicate with different control units 8.

One of the sensor arrangements 3, 4, in the present case the second sensor arrangement 4, is communicatively connected, in the present case exclusively, to the central control unit 11, and another of the sensor arrangements 3, 4, in the present case the first sensor arrangement 3, is communicatively connected to at least one of the control units 8, but in any case not to the central control unit 11.

The central control unit 11 is configured to ascertain the driver request on the basis of sensor signals from at least one of the sensor arrangements 3, 4, in the present case from the second sensor arrangement 4 connected thereto, and to transmit the ascertained driver request to the control unit 8 via the communication connection.

The control units 8 are each configured to receive the transmitted driver request and to control the particular actuator 7 on the basis of the ascertained driver request. Furthermore, at least one of the two control units 8, which in the present case form part of the system 10, is additionally configured to ascertain the driver request also on the basis of sensor signals from at least one of the sensor arrangements 3, 4, in the present case from the first sensor arrangement 3 connected thereto.

To that end, various communication connections are provided, which are indicated by arrows in FIG. 1. The connection can basically be wired or wireless. In particular, the connections are each designed as separate connecting lines.

In the present case, the central control unit 11 is redundantly connected to all of the control units 8 by means of at least two communication connections 13, 14, in particular vehicle bus connections, for example CAN bus connections, in the present case a first connection 13 and a second connection 14.

The sensor elements 5, 6 are also connected via communication connections 15-18 in order to connect the respective sensor arrangements 3, 4. Each of the sensor elements 5, 6 is separately communicatively connected to the particular control unit 8 or to the central control unit 11.

The first sensor element 5 of the second sensor arrangement 4 is connected to the central control unit 11 via a third connection 15, and the second sensor element 6 of the second sensor arrangement 4 is connected to said central control unit via a fourth connection 16.

The first sensor element 5 of the first sensor arrangement 3 is connected to one of the control units 8 via a fifth connection 17, and the second sensor element 6 of the first sensor arrangement 3 is connected to one of the control units via a sixth connection 18. In the present case, the sensor elements 5, 6 are connected to the same control unit 8 of the system 10. The control units 8 of the system 10 are, in particular, also communicatively connected to one another by a connection (not shown), so that at least an indirect connection to the first sensor arrangement 3 exists.

Alternatively or additionally, as indicated by a dashed line branching off from the sixth connection 18, at least one of the sensor elements 5, 6, for example the second sensor element 6, is additionally or exclusively connected to the particular other control unit 8. The first sensor element 5 is then separately communicatively connected to one of the control units 8, and the second sensor element 6 is separately communicatively connected to a further of the control units 8.

An advantageous method for operating the motor vehicle 1 is described below with reference to FIG. 2. For this purpose, FIG. 2 shows the method using a flow chart. In particular, the method ensures that the reliability, fail-safety and reaction time of the motor vehicle are further improved with regard to fulfilling a driver request.

In a step S1, the method begins with the actuation device 2 being monitored for actuation by the sensor arrangements 3, 4 in order to detect a driver request. If an actuation is detected, the method is continued in step S2.

In step S2, the motor vehicle 1 is monitored for a malfunction and/or an emergency situation. In order to detect an emergency situation, in particular a gradient analysis of an actuation of the actuation device 2 is carried out.

Preferably, the central control unit 11, the sensor arrangements 3, 4 connected to the central control unit 11, in the present case the sensor arrangement 4, the communication connections 15-18 between the central control unit 11 and the particular sensor arrangement 3, 4, in the present case the connections 15, 16 to the sensor arrangement 4, and/or the communication connections 13, 14 between the central control unit 11 and the control unit 8 are monitored for a malfunction. If no malfunction and/or emergency situation is/are detected, it is assumed that the motor vehicle 1 is in normal operation and the method is continued in a step S3. However, if an emergency situation and/or a malfunction is detected, the method is continued in a step S4 instead.

Due to the redundancy provided in the present case, the method is continued in step S4 instead of step S3 in particular only if a malfunction is detected that results in the central control unit 11 no longer being able to communicate with the sensor arrangement 4 and/or the control unit 8, i.e., if the central control unit 11 itself, both connections 15, 16 and/or both connections 13, 14 have failed, otherwise the connection that is still functioning serves as a fallback level and it is still possible to continue in step S3.

In step S3, in which the motor vehicle 1, as described, is in normal operation, the driver request is ascertained by means of the central control unit 11 on the basis of sensor signals from at least one of the sensor arrangements 3, 4, in the present case from the sensor arrangement 4 connected thereto, transmitted to the control unit 8 via the connection 13, 14 and received by the control unit 8.

In step S4, in which the motor vehicle 1, as described, is in faulty and/or emergency operation, the driver request is ascertained instead directly by means of the control unit 8 on the basis of sensor signals from at least one of the sensor arrangements 3, 4, in the present case from the sensor arrangement 3 connected thereto, bypassing the central control unit 11.

The method ends in each case with a step S5 in which the particular actuator 7 is controlled by means of the control unit 8 on the basis of the ascertained driver request in order to fulfill the driver request.

1-10. (canceled)

11. A motor vehicle, comprising:
at least one actuation device including a pedal or handle, the actuation device configured to specify at least one driver request including: a braking request and/or an acceleration request and/or a steering request;
at least two sensor arrangements configured to detect an actuation of the actuation device;
at least one actuator controllable to fulfill the driver request, the actuator including: a braking actuator and/or a driving actuator and/or a steering actuator;
at least one central control unit configured to ascertain the driver request based on sensor signals from at least one of the sensor arrangements; and
at least one control unit configured to control the actuator based on the ascertained driver request, the central control unit being communicatively connected to the control unit via a communication connection;
wherein one sensor arrangement of the sensor arrangements is communicatively connected exclusively to the central control unit and another of the sensor arrangements is communicatively connected exclusively to the control unit; and
wherein the control unit is configured to ascertain the driver request based on sensor signals from the sensor arrangement that is connected to the control unit.

12. The motor vehicle according to claim 11, wherein the central control unit is configured to transmit the ascertained driver request to the control unit via the communication connection, and the control unit is configured to receive the transmitted driver request.

13. The motor vehicle according to claim 11, wherein the central control unit is redundantly connected to the control unit by at least two communication connections.

14. The motor vehicle according to claim 11, wherein at least one of the sensor arrangements has first and second sensor elements for redundantly detecting the actuation, the first and second sensor elements using different measuring principles relative to one another.

15. The motor vehicle according to claim 14, wherein the first sensor element and the second sensor element are each communicatively connected, separately, to the control unit or to the central control unit.

16. The motor vehicle according to claim 14, wherein the motor vehicle has, in addition to the control unit, at least one further control unit assigned to the actuator or to a further actuator, and the first sensor element is communicatively connected, separately, to the control unit, and the second sensor element is communicatively connected, separately, to the further control unit.

17. The motor vehicle according to claim 11, wherein the motor vehicle has a braking system, which operates according to the brake-by-wire principle, and the actuator is configured as a brake actuator of the braking system, and the control unit is configured as a brake control unit of the braking system assigned exclusively to the actuator.

18. A method for operating a motor vehicle, the motor vehicle including:
at least one actuation device including a pedal or handle, the actuation device configured to specify at least one driver request including: a braking request and/or an acceleration request and/or a steering request,
at least two sensor arrangements configured to detect an actuation of the actuation device,
at least one actuator controllable to fulfill the driver request, the actuator including: a braking actuator and/or a driving actuator and/or a steering actuator,
at least one central control unit configured to ascertain the driver request based on sensor signals from at least one of the sensor arrangements, and
at least one control unit configured to control the actuator based on the ascertained driver request, the central control unit being communicatively connected to the control unit via a communication connection,
wherein one sensor arrangement of the sensor arrangements is communicatively connected exclusively to the central control unit and another of the sensor arrangements is communicatively connected exclusively to the control unit, and
wherein the control unit is configured to ascertain the driver request based on sensor signals from the sensor arrangement that is connected to the control unit,
the method comprising:
during normal operation of the motor vehicle:
ascertaining the driver request by central control unit;
transmitting the ascertained driver request from the central control unit to the control unit via the communication connection;
receiving the ascertained driver request by the control unit; and
controlling the actuator by the control unit based on the ascertained driver request.

19. The method according to claim 18, wherein the motor vehicle is monitored for a malfunction and/or an emergency situation, and when a malfunction and/or emergency situation is/are detected, the driver request is ascertained instead by the control unit, and the actuator is directly controlled by the control unit based on the ascertained driver request.

20. The method according to claim 19, wherein the central control unit, the sensor arrangement connected to the central control unit, a communication connection between the central control unit and the sensor arrangement and/or the communication connection between the central control unit and the control unit, are monitored for a malfunction.
